(19) United States
(12) Patent Application Publication
(10) Pub. No.: US 2024/0375126 A1
(43) Pub. Date: Nov. 14, 2024

(54) LINEAR GAS SEPARATOR

(71) Applicant: DE.MISSION INC., Calgary (CA)

(72) Inventors: Richard Brent GAROSSINO, Leduc (CA); Kenneth Arnold LAWTON, Edmonton (CA)

(73) Assignee: DE.MISSION INC., Calgary, BC (CA)

(21) Appl. No.: 18/686,827

(22) PCT Filed: Aug. 24, 2022
(86) PCT No.: PCT/CA2022/051284

§ 371 Date: Feb. 26, 2024

(30) Foreign Application Priority Data
Aug. 26, 2021 (CA) 3128992

(51) Int. Cl. B04C 3/06; B01D 53/24; B04C 3/00

(52) U.S. Cl. CPC B04C 3/06; B01D 53/24; B01D 2256/10; B01D 2256/16; B01D 2257/504; B04C 2003/006

(57) ABSTRACT

A linear gas separator includes an elongated housing having an outer peripheral sidewall, an inner peripheral sidewall, a central gas flow passage defined by the inner peripheral sidewall and a peripheral gas flow passage defined by a space between the inner peripheral sidewall and the outer peripheral sidewall. A center rod extends along a longitudinal axis between a first end and a second end. A vortex generator creates a Burger's vortex which causes a density gradient of gases circulating around the center rod. Lighter gases exit through a first outlet approximately aligned with the longitudinal axis. Heavier gases pass along the peripheral gas flow passage and exit through a second outlet.

### CROSS-REFERENCE TO RELATED APPLICATIONS

This application claims the benefit of and claims priority to Canadian Patent Application No. 3,128,992 filed on 26 Aug. 2021.

Each of the aforementioned applications is incorporated by reference herein in its entirety, and each is hereby expressly made a part of this specification.

### TECHNICAL FIELD

The disclosure relates to devices and assemblies for separating gases and, in particular, to linear gas separators for separating gases based upon density.

### BACKGROUND

In industrial processes the separation of gases is typically a pressure, vacuum or temperature swing adsorption system using zeolites or perhaps cryogenic distillation. Typical applications for separating gases like carbon and sulfur dioxide from hydrocarbon combustion are energy intensive using these methods.

### SUMMARY

There is provided a linear gas separator which includes an elongated housing depicted in a substantially vertical orientation. The elongated housing has an outer peripheral sidewall, an inner peripheral sidewall, a central gas flow passage defined by the inner peripheral sidewall and a peripheral gas flow passage defined by a space between the inner peripheral sidewall and the outer peripheral sidewall. The elongated housing has a first end, a second end and a longitudinal axis that extends from the first end to the second end. The elongated housing has a mixed gases inlet at the first end in communication with the central gas flow passage, a first outlet for relatively less dense gases positioned at the second end in approximate alignment with the longitudinal axis, a second outlet for relatively more dense gases positioned at the first end in communication with the peripheral gas flow passage, and a transition inlet between the central gas flow passage and the peripheral gas flow passage at the second end of the elongated housing. A center rod extends along the longitudinal axis between the first end and the second end. A vortex generator is disposed between the mixed gases inlet and the central gas flow passage to create a Burger's vortex which causes a density gradient of gases circulating around the center rod, with less dense gases exiting the elongated housing through the first outlet and more dense gases passing through the transition inlet to the peripheral gas flow passage and exiting the elongated housing through the second outlet.

In an aspect, the disclosure describes a linear gas separator. The linear gas separator also includes an elongated housing having an outer peripheral sidewall, an inner peripheral sidewall, a central gas flow passage defined by the inner peripheral sidewall and a peripheral gas flow passage defined by a space between the inner peripheral sidewall and the outer peripheral sidewall, the elongated housing having a first end, a second end and a longitudinal axis that extends from the first end to the second end, the elongated housing having a mixed gases inlet at the first end in communication with the central gas flow passage, a first outlet for lighter gases positioned at the second end in approximate alignment with the longitudinal axis, a second outlet for heavier gases positioned at the first end in flow communication with the peripheral gas flow passage, and a transition inlet between the central gas flow passage and the peripheral gas flow passage at the second end of the elongated housing, the heavier gases being denser than the lighter gases: a center rod extends along the longitudinal axis between the first end and the second end; and a vortex generator is disposed between the mixed gases inlet and the central gas flow passage to create a burger's vortex to cause a density gradient of gases circulating around the center rod, with the lighter gases exiting the elongated housing through the first outlet and the heavier gases passing through the transition inlet to the peripheral gas flow passage and exiting the elongated housing through the second outlet.

Implementations may include one or more of the following features. The linear gas separator wherein the elongated housing while horizontally oriented has an upper portion and a lower portion, the peripheral gas flow passage being larger adjacent the lower portion than adjacent the upper portion.

Embodiments can include combinations of the above features.

Further details of these and other aspects of the subject matter of this application will be apparent from the detailed description included below and the drawings. These and other features will become more apparent from the following description in which reference is made to the appended drawings, the drawings are for the purpose of illustration only and are not intended to be in any way limiting.

### DESCRIPTION OF THE DRAWINGS

Reference is now made to the accompanying drawings, in which:

FIG. 1 is a perspective view of a linear gas separator;

FIG. 2 is a vortex generator from the linear gas separator of FIG. 1;

FIG. 3 is a side elevation view, in section, of a rod support from the linear gas separator of FIG. 1;

FIG. 4 is an end elevation view of the linear gas separator of FIG. 1;

FIG. 5 is a side elevation view, in section, of the linear gas separator of FIG. 1; and

FIG. 6 is an end elevation view showing compensation for horizontal operation for the linear gas separator of FIG. 1.

### DETAILED DESCRIPTION

Aspects of various embodiments are described in relation to the figures.

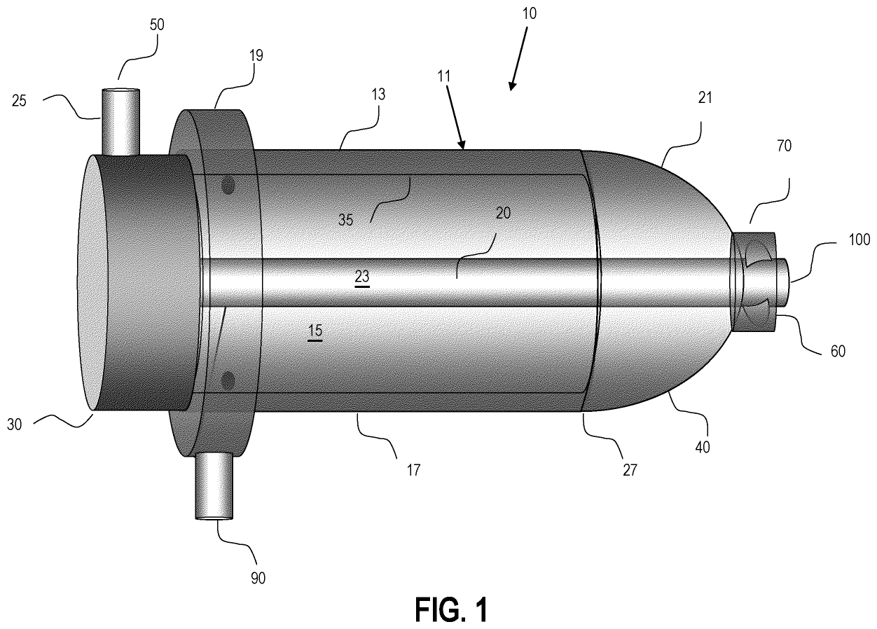

A linear gas separator, generally identified by reference numeral 10, will now be described with reference to FIG. 1 through FIG. 6.

A gas-solid cyclone can be improved by adding a center rod to introduce stability in the axis vortex by reducing turbulent energy losses. Input gas flows into a vortex generator while the radial velocity of the vortex increases from minimum at the surface of the center rod to maximum at the exterior circumference forming an axial helical gas flow about the center rod. A Burger's vortex is characterized by gas spinning at sufficiently high velocity for gases to separate by density whereas at lower velocities the gases rotate as a homogeneous mixture. When the rotational velocity of the gas is high enough to create a Burger's vortex the lower density gases form the axial helical flow around the rod while the outer circumference contains a faster rotating mixture of higher density gases.

A hydrocarbon powered vortex generator, for example, uses the hydrogen in the fuel to heat the nitrogen in the combustion air. As the temperature increases the carbon begins to consume any remaining oxygen in the combustion air producing carbon monoxide first, followed by carbon dioxide. In exhaust the density of the carbon dioxide is 3.6 times higher than the original hydrocarbon fuel; the increased mass is due to the two additional oxygen atoms combining with carbon to form the carbon dioxide. Combining a vortex burner with a linear gas separator allows the lower density hydrogen, water vapour and nitrogen to be separated from the carbon dioxide.

A higher molecular mass gas has a higher density, mass per unit volume, and will rotate faster than a lower density gas. As the rotational velocity inside the gas separator increases, the lower density gas flows axially along the center rod while the higher density gas rotation increases around the axial flow: The pressure driving the linear gas separator is produced by the vortex generator at one end while the opposite end contains a u-turn surface with a central orifice forming a jet to discharge the lower density gas. The higher density gas mixture rotating about the axial flow follows the u-turn surface and exits the linear gas separator in the opposite direction.

### Structure and Relationship of Parts:

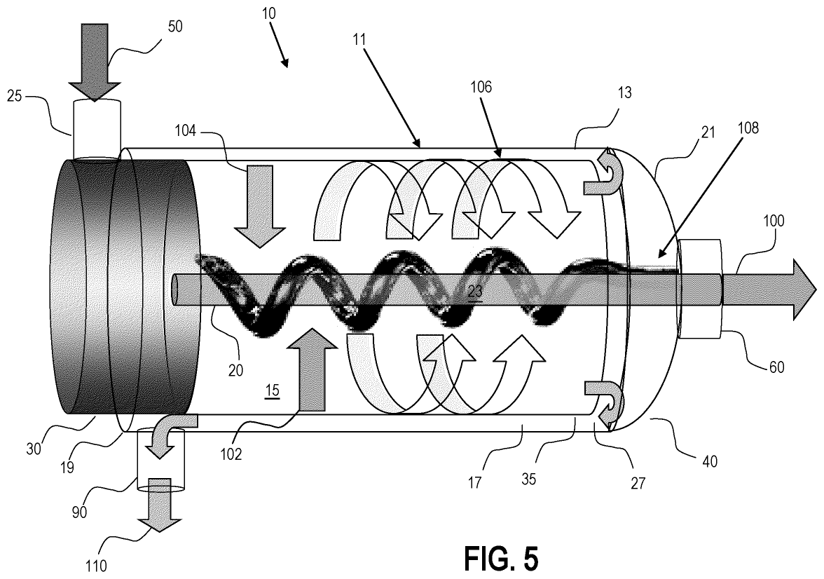

Referring to FIG. 1 and FIG. 5, linear gas separator 10 includes an elongated housing 11 positioned in a substantially vertical orientation. Elongated housing 11 has an outer peripheral sidewall 13 and a cylindrical inner peripheral sidewall 35. A central gas flow passage 15 is defined by inner peripheral sidewall 35. A peripheral gas flow passage 17 is defined by a space between inner peripheral sidewall 35 and outer peripheral sidewall 13. Elongated housing 11 has a first end 19, a second end 21 and a longitudinal axis 23 that extends from first end 19 to second end 21. Elongated housing 11 has a mixed gases inlet 25 at first end 19 in communication with central gas flow passage 15. Mixed gases 50 are received through mixed gases inlet 25. A first outlet 60 is provided for relatively less dense gases positioned at second end 21 in approximate alignment with longitudinal axis 23. A second outlet 90 is provided for relatively more dense gases positioned at first end 19 in communication with peripheral gas flow passage 17. A transition inlet 27 is positioned at second end 21 of elongated housing 11 and allows for the movement of gas between central gas flow passage 15 and peripheral gas flow passage 17. A center rod 20 extends along longitudinal axis 23 between first end 19 and second end 21. A vortex generator 30 is disposed between mixed gases inlet 25 and central gas flow passage 15 to create a Burger's vortex which causes a density gradient of gases circulating around the center rod. As will hereinafter be further described, less dense gases exit elongated housing 11 through first outlet 60 and more dense gases pass through transition inlet 27 to peripheral gas flow passage 17 eventually exiting elongated housing 11 through second outlet 90.

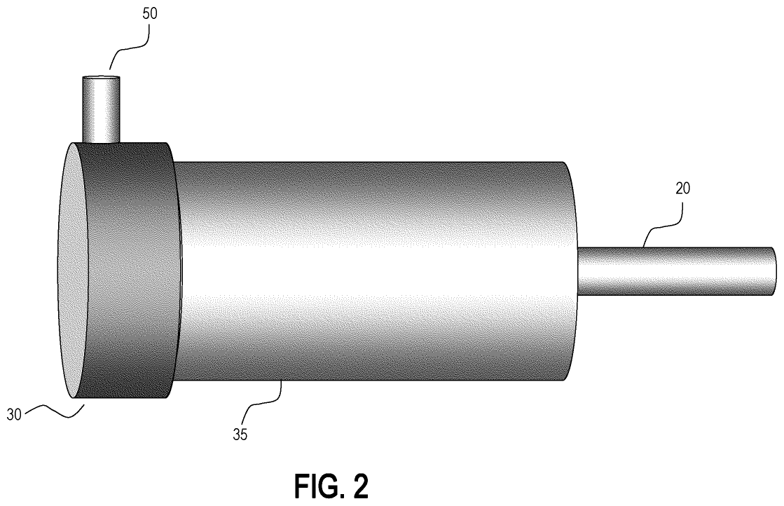

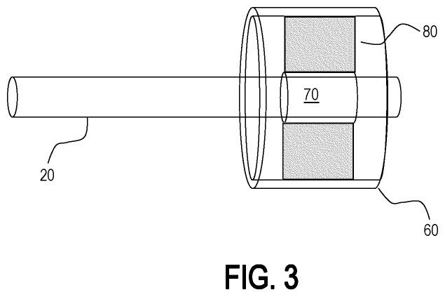

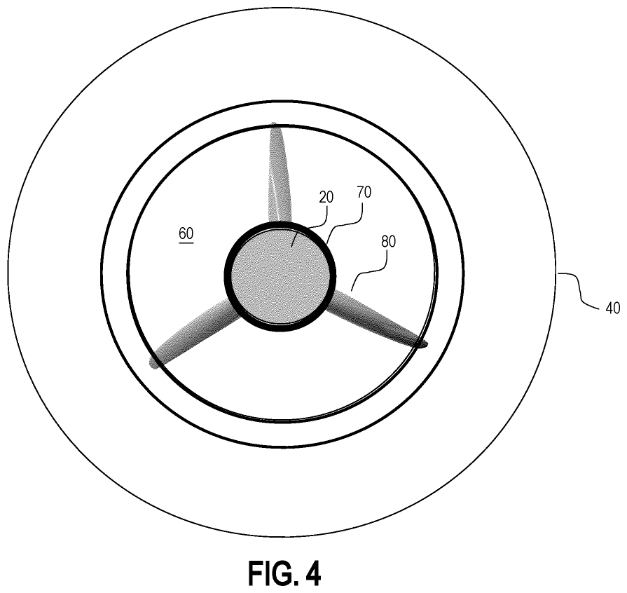

Referring to FIG. 1, linear gas separator 10 includes a center rod 20 originating at a vortex generator 30 generally depicted in FIG. 2 with associated cylindrical inner peripheral sidewall 35. FIG. 1 further demonstrates a hole in u-turn surface 40 at second end 21, that forms the orifice that is first outlet 60, where the lower density gas exits at 100. Referring to FIGS. 3 and 4 shows the center rod 20 rests in the rod support 70 supported by three or more fins 80, as it protrudes through the orifice that is first outlet 60, in the outer u-turn surface 40. The support fins 80, may be pitched to induce a secondary swirl in the discharge 100. The discharge 100 is lower density gas.

Referring to FIG. 5, the gas separator is driven by a vortex generator 30, using a pressurized mixture of gases 50 (shown as mixed gas input). When driven at sufficient velocity a vortex generator forms a Burger's vortex about the center rod 20. Within a Burger's vortex the rotating gas forms a density gradient where lighter gases remain close to the center rod 20, while more dense gases distribute radially, in order of increasing density, outward from the center rod 20, to the cylindrical inner peripheral sidewall 35. As referred to herein, unless otherwise noted or suggested, “heavier gases” refers to more dense gases and “lighter gases” refers to less dense gases.

While the vortex generator spins the mixture of gases, less rotation is induced in those gases with lower molecular mass resulting in an axial flow region wrapped around the center rod. The vortex induces higher rotational velocity due to the higher molecular mass of the more dense gas molecules which forces the denser gases radially outward forming a density gradient proportional to distance from the center rod 20. The heaviest gases rotate at the highest velocity at the cylindrical inner peripheral sidewall 35. As the combination of rotating mixture of gases move axially through the linear region of the gas separator the lower density axial flow discharges through the orifice that is first outlet 60, while the more dense rotating flow follows the u-turn surface 40, exiting at port which is second outlet 90. Higher density gas 110 exits via the second outlet.

FIG. 5 shows the thermodynamic effect of hot gases while operating the separator in the horizontal position. The less dense gases tend to rise (arrow 102) above the higher density gases (arrow 104) causing eccentricity in the axial flow. Arrow 106 indicates higher density, higher spin velocity. Arrow 108 indicates lower density, less spin velocity.

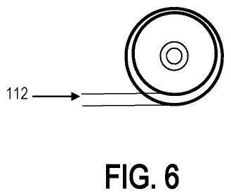

FIG. 6 depicts the compensation method for horizontal operation whereby raising the cylindrical inner peripheral sidewall 35, vertically inside the elongated hosing increasing the lower area for the higher density gas to exit from the bottom of the separator to restore the axial flow symmetry. Arrow 112 shows horizontal compensation.

### APPLICATIONS

The linear gas separator, as described above, can be used for numerous applications.

One application is the use of linear gas separator 10 to reduce the nitrogen and carbon dioxide content of natural gas wells to meet pipeline specifications. Vortex generator 30, combined with the center rod 20, is powered by a gas mixture (gases 50) under pressure, containing lower density wellhead gases like methane and higher density gases like nitrogen and carbon dioxide.

Another application is the use of linear gas separator 10 to separate heavier byproducts of hydrocarbon combustion, such as carbon and sulfur, for example from an exhaust stream. Vortex burner, serves as the vortex generator 30 powering linear gas separator 10, allowing the heavier byproducts of hydrocarbon combustion, carbon and sulfur, to be separated. A less-dense hydrogen and nitrogen containing flow (discharge 100) contains the majority of the heat value. Conversely the higher density carbon and sulfur byproducts are separated and discharged as an exhaust flow through the port that is second outlet 90, that can be captured for sequestration or further processing.

Another application is the use of linear gas separator to sterilize air. In a typical building 90 percent of the air is recycled. A linear gas separator installed in a heating application uses the hydrogen and water vapour to rapidly raise the air to very high temperature incinerating any volatile organic compounds, viable molds and viruses. Since the carbon is removed in the linear gas separator the low density discharge contains only clean hot nitrogen and water vapour. External makeup air supplies the oxygen to the burner instead of consuming the oxygen inside the building.

The embodiments described in this document provide non-limiting examples of possible implementations of the present technology. Upon review of the present disclosure, a person of ordinary skill in the art will recognize that changes may be made to the embodiments described herein without departing from the scope of the present technology. Practical implementation of the features may incorporate a combination of some or all of the aspects, and features described herein should not be taken as indications of future or existing product plans.

What is claimed is:

1. A linear gas separator, comprising:
an elongated housing having an outer peripheral sidewall, an inner peripheral sidewall, a central gas flow passage defined by the inner peripheral sidewall and a peripheral gas flow passage defined by a space between the inner peripheral sidewall and the outer peripheral sidewall, the elongated housing having a first end, a second end and a longitudinal axis that extends from the first end to the second end, the elongated housing having a mixed gases inlet at the first end in communication with the central gas flow passage, a first outlet for lighter gases positioned at the second end in approximate alignment with the longitudinal axis, a second outlet for heavier gases positioned at the first end in flow communication with the peripheral gas flow passage, and a transition inlet between the central gas flow passage and the peripheral gas flow passage at the second end of the elongated housing, the heavier gases being denser than the lighter gases;
a center rod extends along the longitudinal axis between the first end and the second end; and
a vortex generator is disposed between the mixed gases inlet and the central gas flow passage to create a Burger's vortex to cause a density gradient of gases circulating around the center rod, with the lighter gases exiting the elongated housing through the first outlet and the heavier gases passing through the transition inlet to the peripheral gas flow passage and exiting the elongated housing through the second outlet.

2. The linear gas separator of claim 1, wherein the elongated housing while horizontally oriented has an upper portion and a lower portion, the peripheral gas flow passage being larger adjacent the lower portion than adjacent the upper portion.

3. The linear gas separator of claim 2, wherein the second outlet is positioned in the lower portion of the elongated housing, such that the heavier gases passing through the second outlet are assisted by gravity.

4. The linear gas separator of claim 1, wherein the second end of the elongated housing is curved to create a U-turn surface which directs the heavier gases to the transition inlet.
